(19) United States
(12) Patent Application Publication
(10) Pub. No.: US 2010/0195902 A1
(43) Pub. Date: Aug. 5, 2010

(54) SYSTEM AND METHOD FOR CALIBRATION OF IMAGE COLORS

(76) Inventor: Ronen Horovitz, Haifa (IL)

Correspondence Address: Pearl Cohen Zedek Latzer, LLP, 1500 Broadway, 12th Floor, New York, NY, 10036, US

(21) Appl. No.: 12/667,942

(22) PCT Filed: Jul. 10, 2008
(86) PCT No.: PCT/IL08/00961

§ 371 Date: Jan. 6, 2010

Related U.S. Application Data
(60) Provisional application No. 60/929,713, filed on Jul. 10, 2007.

(51) Int. Cl. G06K 9/00

(52) U.S. Cl. 382/162

(57) ABSTRACT

A system and method for correcting or calibrating a color in an image by comparing a value of a color property of at least two colors in the image to a known value of such color property for such colors, calculating a variance of the colors in the image from the known values of the colors, and applying the variance to other colors in the image. Some embodiments include identification of an object in the image as including the known colors.

### FIELD OF THE INVENTION

The invention pertains generally to identification of colors in an image with an expected color in such image.

### DESCRIPTION OF PRIOR ART

U.S. Pat. No. 7,051,935, which issued to Sali, et al., on May 30, 2006, discloses a color bar code system and includes a camera reader to read at least one color bar code having a subset of N bar code colors, a color association unit and an identifier. The color association unit associates each point in a color space with one of the bar code colors. The color association unit may be calibrated to the range of colors that the camera reader is expected to produce given at least one environmental condition in which it operates. The identifier uses the color association unit to identify an item associated with the bar code from the output of the camera reader.

### BACKGROUND TO THE INVENTION

Lighting intensity, illumination source, shadows, angles and other variable factors of a scene in an image may change characteristics or properties of colors that appear in such image. Such changes may impair comparisons of colors in an image with the expected colors of objects in such image, and may impair identification of an object that appears in an image by way of comparison of such color with an expected color of such object.

### SUMMARY OF THE INVENTION

Some embodiments of the invention may include a method of associating a color in an image with a color stored in a memory, where the method includes calculating a first variance between a value of a property of a first color in the image and a value of the property of the first color that may have been known a priori and stored in a memory, calculating a second variance between a value of the color property of a second color in the image and a value of the color property of the second color that may have been known a priori and stored in the memory, calculating an expected variance between a value of the color property of a third color in the image and a value of the color property of the third color stored in the memory, and associating the third color in the image with the third color stored in the memory once the expected variance is applied to the color property of the third color in the image.

In some embodiments, an image may be displayed that shows the object with the third color as it is corrected to be the same as the third color stored in the memory in place of the third color in the captured image.

In some embodiments, an object in the image that has the third color may be identified by the presence of the third color or by an appearance or shape of the object.

In some embodiments, calculating the first variance may be calculated for a color in the image having a highest intensity value from among colors on the object in the image, and the second variance may be calculated for a color in the image having a lowest intensity from among colors on the object.

In some embodiments, a third variance may be calculated as a difference between a value of a color property of a color of an object in one image and the value of the color of the object in a second image, and then the expected variance may be adjusted by a function of a difference between the first variance and the third variance.

In some embodiments, a processor may issue a signal to adjust an imaging parameter of an imager to improve a dynamic range of the captured image.

In some embodiments, the first variance may be calculated on a HSV value of the first color in the image and an HSV value of the first color stored in the memory.

In some embodiments, the variance may be stored as a range of variances.

Some embodiments of the invention may include a method of associating an object in an image with an instance of a set of objects stored in a memory, where the method includes identifying the object in the image as belonging to the set of objects, calculating a first variance between a value of a property of a first color of the object in the image and a value of the property of the first color stored in the memory, calculating a second variance between a value of the property of a second color of the object in the image and a value of the property of the second color stored in the memory, calculating an expected variance between a value of the property of a third color of the object in the image and a value of the property of the third color stored in the memory, associating the third color in the image with the third color stored in the memory upon an application of the expected variance to the property of the third color in the image, and associating the object in the image with a instance from among the set of objects.

In some embodiments, the object in the image may be identified on the basis of a shape of the object, and the first color may be identified on the basis of its position on the object.

In some embodiments values of the color property may be calculated and stored for a wide range of colors based on the expected variance.

Some embodiments of the invention include a system having a memory, an imager to capture an image of an object that has at least three colors, where a value of a color property of each of such colors are stored in the memory, and a processor to differentiate the object in the image from other objects in the image; to compare the value of the color property of the first color in the image to the value of the color property of the first color stored in the memory, to compare the value of the color property of the second color in the image to the value of the color property of the second color stored in the memory, and to calculate a variance of the color property of the third color in the image from the color property of the third color stored in the memory.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic diagram of a system including an imaging device, a processor, a memory and an object having colors thereon in accordance with an embodiment of the invention;

FIG. 2 is a flow diagram of a method in accordance with an embodiment of the invention; and

FIG. 3 is a flow diagram of a method in accordance with an embodiment of the invention.

No reference to scale or relative size of objects should be deduced from their depictions in the figures.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating” “comparing” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution result in a method of an embodiment of the invention.

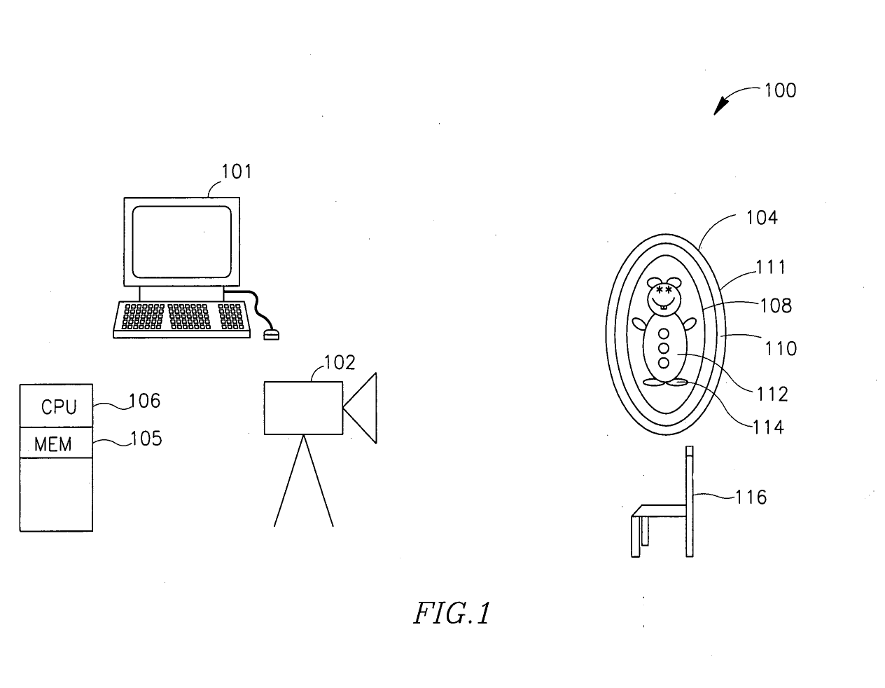

FIG. 1 is a schematic diagram of a system including an imaging device, a processor, a memory and an object to be identified in accordance with an embodiment of the invention. In some embodiments, a system 100 may include for example a screen or display 101 device that may be connected or associated with a processor 106, and an imager 102 that may capture an image of an object 104, and relay or transmit digital information about the image to processor 106. Processor 106 may be connected to or associated with a memory 105.

Object 104 may include or have thereon a number of colored areas 108 that may be arranged for example in a known or pre-defined pattern, such as a series of bars, circles, rectangles or other shapes, on an area of object 104, such as a rim or perimeter 111 of object 104 or on other areas of object 104. Object 104 may include an area 110 that is not colored, or that is colored or blank. For example, the color of area 110 may be white or may be white and black. Object 104 may include a second area 112 that may include one or more other colors 114, such as for example, red, blue, green or others. Second area 112 may be located at a known proximity relative to first area 110. For example, first area 110 may be on an outside, inside, rim, left side, right side or other known position on object 104 relative to second area 112. Other numbers of areas may be used, and colors may be interspersed or otherwise spread among such areas on an object 104.

A property of one or more colors in first area 110 and second area 112 may be known and recorded in memory 105. Such property may include a shade or intensity of one or more of the colors on object 104. For example, a property may include a value of one or more colors in one or both of HSV space or RGB space. Other values or representations or values of a color may be used.

In operation, memory 105 may store data about several objects 104, where such data includes a relative location of certain colored areas 110 and 112 of the object 104 and color values of certain colors in such areas. A user may present or show object 104 to imager 102 so that object 104 is part of an image that is captured by imager 102. Processor 106 may isolate or detect the presence of an object 104 in the captured image, on the basis of for example a pattern or relative position of one or more areas 110 or 112, and may differentiate or recognize the object 104 from other objects 116 in the image that are not relevant or that are not part of a designated set of objects about which data may be stored in memory 105. Processor 106 may also detect a proximity of one area 110 to another area 112. Processor 106 may evaluate one or more of the colors 114 that appear in the captured image and may derive a value, such as an HSV value for such color 114. Other properties in other color spaces such as RGB, Lab or others may be used. For example, data in memory 105 may indicate that object 104 has a first area 110 with a black rim that surrounds a concentric white inner circle. The HSV values of the rim of object 104 or some other area 110 as appears in the captured image may include a region with HSV values of 354, 41, 28. A location on object 104 of such region may be associated in memory 105 as being a black region. Another location or area 110 on object 104 may be associated in memory 105 as including a white color. The HSV values of such white region may be 47, 23, 103. Processor 106 may compare the HSV values of the relevant areas as was detected in the image, with the HSV values for such areas of object 104 as are stored in memory 105. Processor 106 may calculate a variance of the values detected in the black region of the image with the values of the black region as are stored in memory 105. A variance may also be calculated for the white region in the image and the white region stored in the memory 105. Variances for other colors may likewise be calculated and a slope of estimated variances for some or all colors may be established. Colors detected on object 104 in the image may be identified, correlated, corrected or calibrated to the colors stored in memory 105 on the basis of the estimated variance. Identification of one or more colors 114 on object 104 may be used as an identification of a nature of object 104 or as an instance from among a collection of objects known to memory 105.

In some embodiments of the invention, there may be included a game in which a user may be requested to for example make a selection by presenting an object 104 to an imager 102. A display 101 device, associated with a processor 106, may show a scene to the user. For example, a display 101 may request that a user select a game to be played. A user may present or show a card, object 104 or page to the imager, where the card or page includes colors that are associated in a memory 105 with a particular selection of a game. For example, a game card may be a circular card with a black rim and an inner white cirle and may include a picture of a purple elephant The processor 106, which is linked to an imager 102 may differentiate the game card from among other objects 116 in the image and may identify the user's selection upon recognizing the purple inside the white circle on the card.

An object 104 may be placed in the field of view of the imager 102 as part of the calibration process. The imager 102 may detect the presence of the object 104 in the image and then to extract its features from the image for further analyzing its appearance. The analysis may involve determining different areas on the object 104 with certain characteristics which relate to its color properties.

In some embodiments, the calculation of a series of two or more variances of observed color properties versus stored color properties, and a derivation of an expected color variance for various other colors may compensate for effects of the environmental conditions on the images, such as correcting white balance, stretching the contrast of the images in terms of dynamic range, enhancing the color constancy in the images and their color saturation levels, and more.

In some embodiments the calibration scheme can be either calculated specifically per image, per pixel in real-time, or it can be calculated once for all possible combinations of pixel color values and later applied in the form of look-up tables (LUT) that may be generated based on expected variances for one, some or all colors in a spectrum.

In some embodiments, a user may be asked to present or show one or more props to imager 102, such as a shirt or printed object that has known color properties, and a calibration or color identification process may be undertaken without the participant knowing that he or she is calibrating a camera or imager 102. This calibration or correction process may be undertaken automatically once the object 104 is brought into view of imager 102, and may done under unconstrained lighting and angle environments. In some embodiments calibration or calculation of variances and updating of LUTs may be performed in real time on a periodic or continuous basis.

In some embodiments, object 104 may be or include a 2D flat object, such as a card or printed paper, or a 3D object such as a ball, game piece or even a piece of cloth or shirt a user wears. In some embodiments, a 2D prop or object 104 may be used to calibrate colors for other 2D props. A 3D prop can give lighting and illumination information from various angles and may be used to calibrate colors for algorithms which are applied to 3D objects. In some embodiments, an object 104 may include an area that is printed or otherwise applied with a color whose properties are known a priori, and are stored in memory 105.

The colored segments or regions on object 104 may be full solid segments or they may form a pattern, representation or design that may be recognized by a user. Colored regions may be or be included in boundary or other shape around a representation or other image that may be attached to or included on object 104. For example, object 104 may be or include a rectangular shaped multi-colored disk having a picture, such as cartoon attached to a circular object 104 where the cartoon picture may be placed inside a circular pattern of black and white or other colored segments, or on a shirt worn by one or more players or users of a game.

A list of patterns of colored areas 110 or 112 may be associated with one or more objects 104 or figures that may be attached to object 104, and such lists and associations may be stored in a memory 105 that may be connected to processor 106. Returning to the example above, a user may select and present to an imager a card from a set of games cards. Some of such cards may have for example a black rim and inner white circle, or some other patterns, and one may have a picture of a red pirate. Another may have a picture of a yellow and green clown. Processor may identify a particular card as being an instance from among the set of game cards, and may associate the presented card with an initiation of a game that is associated with the card.

In some embodiments, an object 104 may be detected or differentiated from other objects 116 in an image, as belonging to a class of objects whose colors are to be compared to colors stored in memory 105, and such detection may be performed before calibration of colors in the image. Detection, differentiation or discrimination of the relevant object 104 in the image from other non-relevant objects 116 in the image may be based on for example a known shape, form or other characteristic of object 104, and may rely on for example shape analysis techniques. For example, if object 104 has a circular form, circle detection techniques may be applied. The circular form may be emphasized by, for example, adding adjacent black and white concentric boundary circles on a rim or perimeter 111 of object 104 or elsewhere. Other colors, proximities and shapes may be used. By using contiguous black and white areas, a high intensity contrast may be created, and such contract may facilitate easier detection of the object 104. Other colors may be used. In some embodiments, circle detection may be based on the Hough transform or other operator.

In some embodiments, a circle detection process may be undertaken by applying a color gradient operator on the original image as follows:

Let the following quantities be defined in terms of the dot product of the unit vectors along the R, G and B axis of RGB color space:

$${g}_{xx} = {\vert \frac{\partial R}{\partial x} \vert}^{2} + {\vert \frac{\partial G}{\partial x} \vert}^{2} + {\vert \frac{\partial B}{\partial x} \vert}^{2}$$

$${g}_{yy} = {\vert \frac{\partial R}{\partial y} \vert}^{2} + {\vert \frac{\partial G}{\partial y} \vert}^{2} + {\vert \frac{\partial B}{\partial y} \vert}^{2}$$

$${g}_{xy} = \frac{\partial R}{\partial x} \frac{\partial R}{\partial y} + \frac{\partial G}{\partial x} \frac{\partial G}{\partial y} + \frac{\partial B}{\partial x} \frac{\partial B}{\partial y} .$$

R, G and B, and consequently the g's are functions of x and y.
The direction of maximum rate of change of the image as a function of (x,y) is given by the angle:

$$θ ( x , y ) = \frac{1}{2} {tan}^{- 1} [ \frac{2 {g}_{xy}}{( {g}_{xx} - {g}_{yy} )} ]$$

and the value of the rate of change, i.e. the magnitude of the gradient, in the directions given by the elements of theta(x,y) is given by:

$${F}_{θ} ( x , y ) = {\{ \frac{1}{2} [ ( {g}_{xx} + {g}_{yy} ) + ( {g}_{xx} - {g}_{yy} ) cos 2 θ + 2 {g}_{xy} sin 2 θ ] \}}^{1 / 2}$$

Note that the last two equations are images of the same size as the input image, where F is the gradient image.

The result of the gradient image may be thresholded to create a binary image where high levels of color gradient values appear as white, having a value 1. Other pixels may appear as black, having a value 0. The threshold level may be set by using either a fixed threshold or an adaptive threshold that may be calculated based on the statistics of the gradient image.

Pixels in the binary image that are white may be tested to determine if they are part of a circle with radius R or a group of radiuses around R for a set of potential radiuses. The tested pixel may be replaced by a set of pixels that generate a circle around the tested pixel with a radius R, for example. An image of all possible circles around all white pixels is accumulated and then smoothed. At the point where there are true circle centers, a high value appears as all the pixels that belong to the true circle contribute to that value in its center.

In some embodiments a curvature of every white pixel in the binary image and one or more of its neighboring white pixels may be calculated so that the processor 106 accumulates pixels which are R radius in the direction of the inner circle created by these curvatures of each white pixel. For each set of radiuses R−k to R+k an accumulated image may be created. The accumulated images may be tested to find the maximal value and this value will be taken as representing the radius and its center. This detection based on inner radius pixels and curvature may be implemented in a coarse-to-fine hierarchical way. Coarse values can be 10, 20, 30 . . . 60 pixels and then finer values for the radius chosen. If for example, radius 30 is chosen in the first iteration, then a second pass with radiuses 25-35 may be tested to find the exact radius more accurately.

The position and radii found that are identified may be used to detect, isolate or identify the object 104 in the image that will be the subject of further color analysis, correction or calibration. Other methods can be used for circle detection and for detecting other shapes of objects 104.

In some embodiments, when object 104 is detected in the image, processor 106 may deliver a command to imager 102 to adjust one or more imaging parameters to improve an appearance of object 104 in the image. For example, if the brightest intensity value on object 104 is above a threshold level such as 240, processor 106 may issue a signal to imager 102 to decrease exposure settings such as shutter and gain in the capture process. Other commands such as white balance settings or signals may be automatically sent to imager 102 to improve one or more parameters of images to be captured. A default auto-exposure or auto white balance algorithm of imager 102 may be overridden by such as adjustment to reduce back-light effects on object 104.

In some embodiments, object 104 may include predefined solid areas of specific predefined colors having known values for particular color parameters or properties, and which are discernible in an image captured by imager 102. Such known parameters may be stored in memory 105. The region having the white color may have different values than those stored as a result of for example different illumination types such as daylight illumination, incandescent or fluorescent light sources, which may cause the region to appear reddish, yellowish or bluish, depending on the illumination type. This effect may be shared by other colors whose values or parameters may be shifted in a color space to other values.

For example, in HSV color space, a saturation level of a white pixel is near zero while its value or intensity is nearly full, e.g. 1 or 255. Therefore, an image of the V*(1−S) may be thresholded to find areas with bright values.

For RGB color space, the white pixels have the highest intensity or brightness which can be calculated by (R+G+B)/3

Once white pixels in the calibration object 104 are detected, the analysis of the color coordinates of that white segment may allow compensation for the effects of the wrong white balance image, by applying a suitable white balance correction algorithm. In some examples, a ‘gray world’ algorithm may be applied. An algorithm such as the following may also be used

1. Transforming the white pixels values from RGB color space to rgb normalized color space by dividing their values by their brightness to reduce the effect of the illuminator and to better represent their chromatic properties:

r=R/(R+G+B), g=G/(R+G+B), b=B/(R+G+B).

2. Calculating the mean value of the histograms of white pixels in the normalized rgb color space. If the image is bluish, for example, then the mean value of the histogram for the normalized b channel is higher than the normalized r and g channels.

3. Shifting the mean value of the histograms, by for example Gamma correction, to a common level where each channel has approximately the same amount of energy, thereby neutralizing the effect of a dominant color channel.

4. Transforming back to RGB to reveal a white balance corrected image.

In some embodiments, after extraction or isolation of object 104 from the image, and compensating the white balance, a further analysis of other properties of object 104 may be performed. In some embodiments, such an analysis may include for example color segmentation to detect other colored regions as required. The color segmentation may be implemented by using the known a-priory number of colored segments in object 104 along with a k-means clustering-based segmentation in RGB or in Lab color space where the color coordinates may be discriminated. For example, six color segments may be used—White, Black, Red, Green, Blue, Yellow. A white region may be extracted, and may be identified for example as a region of object 104 having a high or highest intensity. Similarly, a black region may be identified by finding a region in object 104 having a lowest intensity value, or in HSV color space, having a lowest value expressed as follows: (1−V)*(1−S). A set off, or expected variance for the white and black regions may be established.

5. Other colors may be identified by testing for example a mean hue component of the segments in HSV color space. The segment which represents the red color may have a Hue value around 0°, the yellow segment may have a value around 60°, the green around 120°, blue around 240°, etc. A set off or variances for some or all of these colors may also be established by contrasting the detected values with known values. In some embodiments, a region of object 104 may be known to include a particular color 114, and such a priori knowledge may add to the accuracy of a detection of a color and a calculation of its variance.

For compensating low dynamic range images, regions of both white and black colored pixels are determined in the calibration object 104 image and used to calculate two mean brightness indicators for the white and black pixels. Based on these two indicators, a contrast stretching transformation may be calculated. The stretching transformation may be implemented by using a LUT which maps the values in the intensity component of the image to new values in such that values between mean black brightness and mean white brightness map to values between 0 and 255.

Before the stretching can be performed it may be necessary to specify the upper and lower pixel value limits over which the image is to be normalized. These limits may be the minimum and maximum pixel values that the image type concerned allows. For example for 8-bit gray level images the lower and upper limits might be 0 and 255. Lets call the lower and the upper limits a and b respectively.

A way for normalization can scan the image to find the lowest and highest pixel values currently present in the image. Call these c and d. Then each pixel P is scaled using the following function:

$${P}_{out} = ( {P}_{in} - c ) ( \frac{b - a}{d - c} ) + a$$

Values may be cropped to the range 0-255.

The extraction and analysis of colored regions in the calibration object may create a set of operations that are implemented as part of the calibration scheme. Red, green and blue may be used to create a higher level of color constancy in the image, meaning that a pure red colored object may appear as red in the image with RGB values close to (255,0,0). Similarly, green may appear with values (0,255,0) and blue with (0,0,255). This can greatly improve the performance of tracking and recognition algorithms which are based on true colors as part of the set of features they use. For example, for achieving better color constancy, regions of different colored pixels may be detected, such as red, yellow, green and blue regions, and their properties in different color spaces are extracted. Properties, such as the mean saturation level in the HSV color space may indicate the vividness of the image. Stretching the saturation component according to the maximal saturation value of these regions in the same manner as described above for the contrast enhancement can greatly improve the natural appearance of the colors in the image. Finding a mean chromatic value of these colored regions and shifting them by a linear LUT, for example, to their desirable locations on a hue scale, for example, will also greatly improve the color constancy in the image and video. In some embodiments, an interpolation or linear plotting of an expected variance for colors may be used to add expected color values for colors whose values were not known a priori. Non-linear methods may also be used in constructing the LUT such as splines or Bicubic interpolation.

In some embodiments, after calculating the desirable transformations as described above in the calibration stage, images or frames in a video sequence are transformed accordingly.

The proposed method can be used for on-the-fly real time calibration for toys and video games which incorporate image processing capabilities and may be used in unconstrained environments and lighting conditions. The calibration can be indiscernible by actually integrating it into a game such as asking a user to select a specified game from a predefined set of games, each having its own picture, by showing the relevant picture to the camera and performing the suggested calibration as described before starting the game.

In some embodiments, colors detected in the image may be corrected when shown on display 101 or for other purposes. For example, detected colors may be shifted as close as possible to the pure values of colors, (255,0,0) for red, for example, or the calibration can just learn the values of the colors and then use a distance metric in a color space, such as Lab, HSV or other to classify the colors in a later image according to these values. The recognition and shifting of the color may allow showing a likeness of the object 104 on display 107, even if some or most of the object is occluded or otherwise not visible in an image.

The values learned from the calibration may also be adaptively updated to compensate for changes in illumination or lighting conditions in an ongoing or real time process by, for example, testing a fixed set of pixels around the image and refining the variance or LUTS according to changes in the scene. For example, if a variance of one or more colors has been established in a first calibration process, a second calibration process may be undertaken to measure a change in a variance of colors in the image, such variance being either from a known value of a color property or from a value detected in a prior calibration process. For example, if in a first calibration process, a variance of a white in an image from an a priori known white of an object 104 is 150 grey levels, and in such first calibration process a variance of a black in an image from an a priori known black of an object 104 is 28 grey levels, a measure of these or other variances may be calculated in a second calibration process and compared to the first set of variances. A new set of variances may then be used to update a LUT to account for changes in illumination. In some embodiments, variances may be calculated for colors other than white and black, and for objects 116 in an image other than object 104. For example, a change in a color value of for example an inanimate object 116 in an image may be monitored for example a grey couch in the background of an image. A change in a color value of such an object 116 as such value is captured in a first image and then in a second image may be used as an indication of a change in the general illumination of a scene, and may be used as a signal to update the LUT for some or all colors in the image or to recalculate the variance applied to some or all of the colors in the image.

The calibration process may also be used to calibrate other properties such as image blur and focus and others.

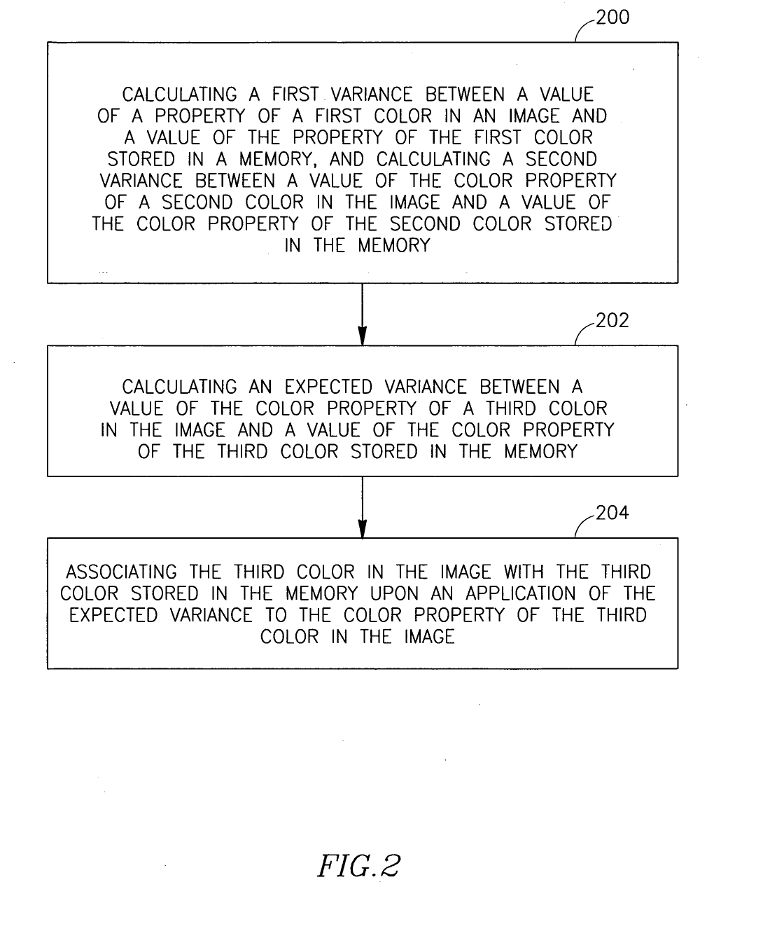

Reference is made to FIG. 2, a flow diagram of a method in accordance with an embodiment of the invention. In some embodiments, a method may associate or identify a color appearing in an image with a color stored in a memory by comparing values of one or more properties of the color in the image with a value of the color that may be stored in a memory. In block 200, a variance may be calculated of a spread or difference between a value of a property of a first color, such as the color white on a particular object in the image or another color with a high intensity, and the value of such color white on such object as is stored in a memory, a second variance may be calculated between the value of the color property for a second color, such as the color black or some other color having a low intensity, that appears on an object in the image and a value of the color property that is stored in the memory. In block 202, an expected variance of the value of the color properties of one or more other colors may be calculated. In block 204 such a variance may be applied to the third color in the image to identify other colors that may appear in the image, or to associate a value of a color property of some other colored area in the image with a color that is recognized in the memory. In some embodiments, an object whose colors or values for color properties are known, may be recognized or identified by a processor by applying the expected variance to the color values detected in the image.

In some embodiments, a display may show the object in the image using the colors that are stored in the memory, such that the processor may correct or alter or replace the colors detected in the image with the colors for the relevant objects as are stored in the memory.

In some embodiments, colors appearing on an object in the image may be identified by eliminating a first high intensity color that was identified, and then selecting a next lower intensity color on the object. The value of the next lower intensity color may be associated with or identified as a color whose value is stored in a memory. This process may be continued until some or all of the colors on the object are identified or associated with colors stored in a memory. In some embodiments, a variance may include a range of variances that may be applied to a color value, so that a color may be guessed by processors if the color in the image falls within a range of variations in color values

In some embodiments, calculating the first variance may include a variance of a color having a highest intensity value from among the colors on the identified object, and calculating a second variance includes calculating a variance of second color having a lowest intensity from among colors on the object.

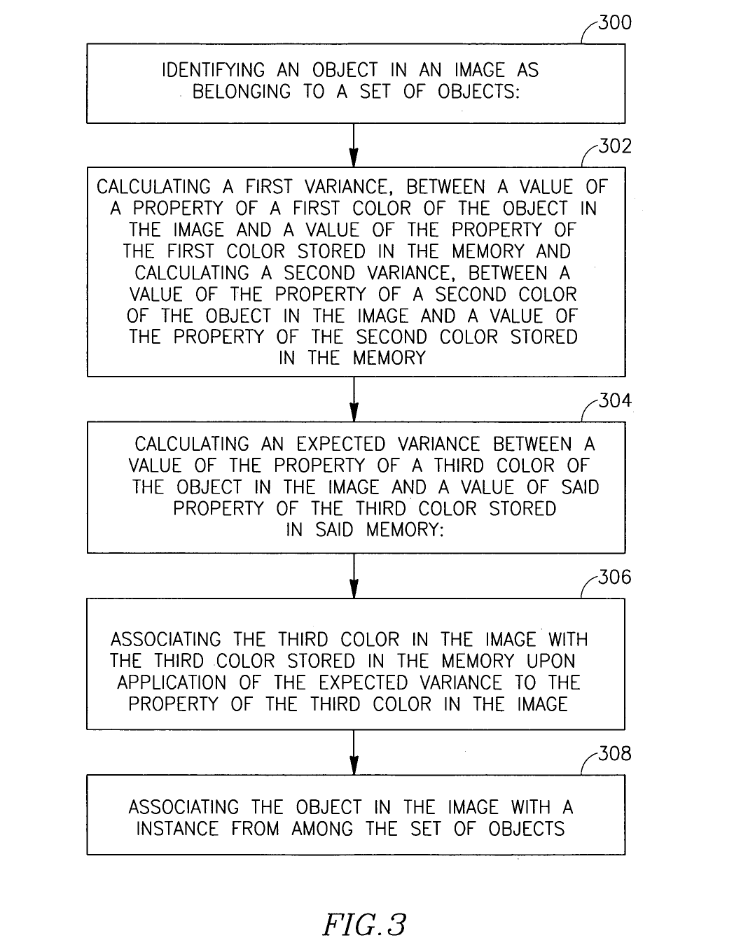

Reference is made to FIG. 3, a flow diagram of a method of associating an object in an image with a particular object from among a set of objects stored in a memory. In some embodiments, in block 300 the method may include identifying the object in an image as belonging to the set of objects, and thereby differentiating the relevant object from other less relevant objects in the image. In block 302, there may be calculated a first variance between a value of a property of a first color of the differentiated object in the image from a value of the property of such color of such object that was known and stored in the memory. The value of the color property may be or include an RGB or HSV value of the color, or some other property. This same process of calculating a variance may be performed for a second color in the image so that a variance of such property of the second color in the image from the second color in the memory is also calculated. In block 304, an expected variance may be calculated for a third color that is in the image. The expected variance may be derived for example by interpolating the variance calculated for the first two colors or by other methods. In block 306, the expected variance may be applied to the color data of a third color in the image. In block 308, the object in the image may be associated with an instance of an object from among a set of relevant objects on the basis of the matching of the third color in the image with the third color stored in the memory.

In some embodiments, the object in the image may be identified based on its shape and the first color may be identified based on its position on the object.

In some embodiments, a processor may automatically issue a signal to adjust a parameter of an imager to improve a dynamic range of the color property of the first color.

It will be appreciated by persons skilled in the art that embodiments of the invention are not limited by what has been particularly shown and described hereinabove. Rather the scope of at least one embodiment of the invention is defined by the claims below.

I claim:

1. A method of associating a color in an image with a color stored in a memory comprising:
calculating a first variance, said first variance between a value of a property of a first color in said image and a value of said property of said first color stored in said memory;
calculating a second variance, said second variance between a value of said color property of a second color in said image and a value of said color property of said second color stored in said memory;
calculating an expected variance between a value of said color property of a third color in said image and a value of said color property of said third color stored in said memory; and
associating said third color in said image with said third color stored in said memory upon an application of said expected variance to said color property of said third color in said image.

2. The method as in claim 1, wherein said image comprises a captured image, and comprising showing in a displayed image said third color stored in said memory in place of said third color in said captured image.

3. The method as in claim 1, comprising identifying an object in said image by the presence of said third color in said image on said object.

4. The method as in claim 1, wherein said calculating said first variance comprises:
calculating said first variance of said first color on a designated object in said image, said first color having a highest intensity value from among colors on said object in said image, and
wherein calculating said second variance comprises calculating said second variance of said second color on said designated object in said image, said second color having a lowest intensity from among colors on said object in said image.

5. The method as in claim 1, wherein said image comprises a first image, and comprising:
calculating a third variance, said third variance between a value of a property of said first color as said first color appears in a second image and a value of said property of said first color as is stored in said memory; and
adjusting said expected variance by a function of a difference between said first variance and said third variance.

6. The method as in claim 1, comprising issuing a signal to adjust an imaging parameter of an imager to improve a dynamic range of said image.

7. The method as in claim 1, wherein said calculating said first variance comprises calculating said first variance between an HSV value of said first color in said image and an HSV value of said first color stored in said memory.

8. The method as in claim 1, wherein said calculating said expected variance comprises calculating a range of a variance of said value of said property.

9. A method of associating an object in an image with an instance of a set of objects stored in a memory, comprising:
identifying said object in said image as belonging to said set of objects;
calculating a first variance, said first variance between a value of a property of a first color of said object in said image and a value of said property of said first color stored in said memory;
calculating a second variance, said second variance between a value of said property of a second color of said object in said image and a value of said property of said second color stored in said memory;
calculating an expected variance between a value of said property of a third color of said object in said image and a value of said property of said third color stored in said memory;
associating said third color in said image with said third color stored in said memory upon application of said expected variance to said property of said third color in said image; and
associating said object in said image with a instance from among said set of objects.

10. The method as in claim 9, wherein identifying said object in said image comprises, identifying said object based on a shape of said object, and comprising identifying said first color by its position on said object.

11. The method as in claim 9, comprising automatically issuing a signal to adjust an imaging parameter of an imager to improve a dynamic range of said color property of said first color.

12. The method as in claim 9, wherein said calculating said expected variance comprises calculating a range of said expected variance.

13. The method as in claim 9, comprising storing in said memory an expected value of said property for a fourth color and for a fifth color.

14. The method as in claim 9, wherein said object comprises a first object and said image comprises a first image, and comprising:
selecting a second object in said image having a colored area;
comparing a value of said property of said colored area in said second object in said first image to a value of said property of said colored area in said second object; and
adjusting said expected variance to be used in said second image based on said comparison.

15. A system comprising:
a memory;
an imager to capture an image of an object, said object having a first color, a second color and a third color, where a value of a color property of said first color and said second color are stored in said memory;
a processor, said processor to:
differentiate said object in said image from other objects in said image;
compare said value of said color property of said first color in said image to said value of said color property of said first color stored in said memory;
compare said value of said color property of said second color in said image to said value of said color property of said second color stored in said memory; and
calculate a variance of said color property of said third color in said image from said color property of said third color stored in said memory.

16. The system as in claim 15, wherein said processor is to differentiate said object from among a set of objects stored in said memory on the basis of the appearance of said third color on said object in said image.

17. The system as in claim 15, wherein said processor is to differentiate said object in said image from other objects in said image by recognizing a shape of said first color and said second color on said object.

18. The system as in claim 15, wherein said object comprises a first object and said image comprises a first image, and wherein said processor is to compare said color property of a second object in said first image, to said color property of said second object in a second image, and is to adjust said variance of said color property of said third color in said second image on the basis of said comparison.
